(19) United States
(12) Patent Application Publication
(10) Pub. No.: US 2026/0257636 A1
(43) Pub. Date: Sep. 3, 2026

(54) IN-VEHICLE DEVICE, PROGRAM, AND INFORMATION PROCESSING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Kazutaka NAITO, Yokkaichi-Shi, Mie (JP); Kota ODA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/865,049

(22) PCT Filed: May 2, 2023
(86) PCT No.: PCT/JP2023/017173

§ 371 Date: Nov. 12, 2024

(30) Foreign Application Priority Data
May 20, 2022 (JP) 2022-083223

(51) Int. Cl. B60R 16/03; B60W 50/023

(52) U.S. Cl. CPC B60R 16/03; B60W 50/023

(57) ABSTRACT

An in-vehicle device connects to a drive device mounted in a vehicle. The drive device includes a first power feeding switch connected to a first in-vehicle load and a second power feeding switch connected to a second in-vehicle load. The in-vehicle device includes a first processing unit and a second processing unit. The first processing unit connects to the first power feeding switch and outputs a first control signal to drive the first in-vehicle load. The second processing unit connects to the second power feeding switch and outputs a second control signal to drive the second in-vehicle load. The first and second processing units are connected to each other. If the first processing unit fails, the second processing unit outputs a third control signal to drive the first in-vehicle load via a first signal line connecting the first processing unit and the first power feeding switch.

### CROSS-REFERENCE TO RELATED APPLICATIONS

This application is the U.S. national stage of PCT/JP2023/017173 filed on May 2, 2023, which claims priority of Japanese Patent Application No. JP 2022-083223 filed on May 20, 2022, the contents of which are incorporated herein.

### TECHNICAL FIELD

The present disclosure relates to an in-vehicle device, a program, and an information processing method.

### BACKGROUND

In a vehicle, for example, a body Electronic Control Unit (ECU) serving as an in-vehicle ECU that performs overall control of body system devices, such as a wiper drive device, light devices internal and external to the vehicle, a door lock device, and a power window motor, is mounted (e.g., JP 2017-224926A). The wiper drive device of JP 2017-224926A includes the in-vehicle ECU (body ECU), and is driven by a control program applied to the in-vehicle ECU.

In the wiper drive device of JP 2017-224926A, there is no separation between a control device (control circuit) that executes a control program to control an actuator (in-vehicle load) such as a wiper, and a drive device (drive circuit) that drives the actuator (in-vehicle load). Moreover, no consideration has given to redundancy of the control device (control circuit) for the drive device (drive circuit).

An object of the present disclosure is to provide an in-vehicle device or the like that allows a drive device to be efficiently controlled.

### SUMMARY

An in-vehicle device according to an aspect of the present disclosure is an in-vehicle device configured to be communicably connected to a drive device mounted in a vehicle and including a first power feeding switch connected to a first in-vehicle load and a second power feeding switch connected to a second in-vehicle load, the in-vehicle device including: a first processing unit configured to be communicably connected to the first power feeding switch, and output a first control signal for driving the first in-vehicle load to the first power feeding switch, a second processing unit configured to be communicably connected to the second power feeding switch, and output a second control signal for driving the second in-vehicle load to the second power feeding switch, wherein the first processing unit and the second processing unit are communicably connected to each other, and, if the first processing unit has failed, the second processing unit outputs a third control signal for driving the first in-vehicle load to the first power feeding switch via a first signal line connecting the first processing unit and the first power feeding switch to each other.

### Effects

According to an aspect of the present disclosure, it is possible to provide an in-vehicle device or the like that allows a drive device to be efficiently controlled.

### BRIEF DESCRIPTION OF DRAWINGS

FIG. 1 is a schematic diagram illustrating a system configuration of an in-vehicle system according to Embodiment 1.

FIG. 2 is a block diagram illustrating an internal configuration of an in-vehicle device and so forth included in the in-vehicle system.

FIG. 3 is a flowchart illustrating processing executed by a second processing unit included in the in-vehicle device.

FIG. 4 is a schematic diagram illustrating a system configuration of an in-vehicle system according to Embodiment 2 (separate in-vehicle devices).

FIG. 5 is a schematic diagram illustrating a system configuration of an in-vehicle system according to Embodiment 3 (mutual replacement).

### DETAILED DESCRIPTION OF PREFERRED EMBODIMENTS

First, embodiments of the present disclosure will be listed and described. At least some of the aspects described below may be combined freely.

An in-vehicle device according to an aspect of the present disclosure is an in-vehicle device configured to be communicably connected to a drive device mounted in a vehicle and including a first power feeding switch connected to a first in-vehicle load and a second power feeding switch connected to a second in-vehicle load, the in-vehicle device including: a first processing unit configured to be communicably connected to the first power feeding switch, and output a first control signal for driving the first in-vehicle load to the first power feeding switch, a second processing unit configured to be communicably connected to the second power feeding switch, and output a second control signal for driving the second in-vehicle load to the second power feeding switch, wherein the first processing unit and the second processing unit are communicably connected to each other, and, if the first processing unit has failed, the second processing unit outputs a third control signal for driving the first in-vehicle load to the first power feeding switch via a first signal line connecting the first processing unit and the first power feeding switch to each other.

According to such an aspect, the in-vehicle device is, for example, a device (ECU) including a plurality of processing units (multiple microcomputers) composed of the first processing unit (first microcomputer) and the second processing unit (second microcomputer), each of which is constituted by a microcomputer or the like. The in-vehicle device and the drive device (extender) that drives the first in-vehicle load and the second in-vehicle load are configured as separate devices, and the in-vehicle device and the drive device are communicably connected. In the connection configuration between the in-vehicle device and the drive device, the first processing unit and the first power feeding switch included in the drive device are connected via the first signal line. The second processing unit is communicably connected to the first processing unit, and cyclically or steadily monitors the operating state of the first processing unit by, for example, performing polling communication with the first processing unit. If the cyclical communication with the first processing unit has been interrupted, the second processing unit determines that the first processing unit is in an abnormal state (functionally failed), and outputs the third control signal for driving the first in-vehicle load to the first power feeding switch via the first signal line. In this case, the third control signal may have the same signal form (specification) as the first control signal. That is, by outputting the third control signal similar to the first control signal, the second processing unit may replace the first processing unit that outputs the first control signal. Alternatively, the third control signal output by the second processing unit may have a signal form (specification) different from that of the first control signal output by the first processing unit, but the first power feeding switch may be configured to perform the same on-off control for both the first control signal and the third control signal, and absorbs the difference between these signal forms (specifications). Thus, for example, even if when the first processing unit has functionally failed, the second processing unit can continue the drive control for the first in-vehicle load by replacing the first processing unit to output the third control signal, thus making it possible to construct a fail-safe environment. When the first processing unit has functionally failed, the third control signal output from the second processing unit to the first processing unit is output via the first signal line. In this manner, the first signal line used by the second processing unit when relacing the first processing unit is the signal line (first signal line) used by the first processing unit during a normal operation, and it is therefore possible to construct a fail-safe environment without increasing the number of signal lines provided between the in-vehicle device and the drive device. Accordingly, when the in-vehicle device and the drive device are spaced apart from each other, there is no need to additionally install signal lines between the in-vehicle device and the drive device in order to construct a fail-safe environment, and it is therefore possible to reduce the component costs and the device weight.

In an in-vehicle device according to an aspect of the present disclosure, the first signal line and the second processing unit are connected to each other by a connecting line, and, if the first processing unit has failed, the second processing unit outputs the third control signal via the connecting line and the first signal line.

According to such an aspect, the connecting line extending from the second processing unit is connected to the first signal line, or in other words, a connection end to which the connecting line is connected is formed on the first signal line. The connection end corresponds to a branching part where the connecting line is branched from the first signal line. Since the third control signal from the second processing unit is output to the first power feeding switch via the connecting line and the first signal line, the third control signal can be output from the second processing unit to the first power feeding switch, using a relatively simple configuration.

In an in-vehicle device according to an aspect of the present disclosure, the connecting line is provided with a conversion unit configured to convert the third control signal into the first control signal, the third control signal output by the second processing unit via the connecting line is converted into the first control signal by the conversion unit, and the first control signal converted by the conversion unit is output to the first power feeding switch via the first signal line.

According to such an aspect, the connecting line is provided with the conversion unit that converts the third control signal output by the second processing unit into the first control signal that is output by the first processing unit in a normal state. The conversion unit may be constituted by, for example, a circuit, an integrated circuit (IC), or the like that performs signal conversion, including, for example, a filter circuit, a PWM waveform conversion circuit, and an output voltage conversion circuit. Alternatively, the conversion unit may be constituted by a microcomputer or the like, and convert the third control signal into the first control signal through software processing. By using the conversion unit in this manner, even if there is any difference between the signal output specification of the second processing unit and the signal output specification of the first processing unit when the second processing unit replaces the first processing unit due to a functional failure of the first processing unit, the difference between the signal output specifications can be absorbed because the third control signal is converted into the first control signal by the conversion unit.

In an in-vehicle device according to an aspect of the present disclosure, a communication cable extending from an operation switch for operating the first in-vehicle load is connected to the first processing unit and the second processing unit.

According to such an aspect, the vehicle is provided with the operation switch for operating the first in-vehicle load, and an occupant of the vehicle can start or stop the driving of the first in-vehicle load by operating the operation switch. For example, when the first in-vehicle load is a wiper, the operation switch corresponds to a wiper switch. The communication cable, such as a wire harness, extending from the operation switch is, for example, branched into two portions, whereby respective end portions of the communication cable are connected to the first processing unit and the second processing unit. Thus, an operation signal generated when the operation switch is operated is input to both the first processing unit and the second processing unit. The first processing unit when operating normally performs on-off control of the first power feeding switch by outputting the first control signal according to the input (obtained) operation signal. If it is determined that the first processing unit is in an abnormal state (functionally failed), the second processing unit performs on-off control of the first power feeding switch by outputting the third control signal substantially corresponding to the first control signal, according to the input (obtained) operation signal. By connecting the communication cable extending from the operation switch to the in-vehicle device to both the first processing unit and the second processing unit to achieve redundancy in this manner, it is possible to efficiently perform alternative processing (fail-safe) by the second processing unit for the first processing unit.

In an in-vehicle device according to an aspect of the present disclosure, the in-vehicle device is composed of a first in-vehicle device and a second in-vehicle device, the first in-vehicle device includes the first processing unit, the second in-vehicle device includes the second processing unit, and, if the first in-vehicle device has failed, the second in-vehicle device replaces the first in-vehicle device.

According to such an aspect, the in-vehicle device includes the first in-vehicle device including the first processing unit and the second in-vehicle device including the second processing unit, and is separated by the first in-vehicle device and the second in-vehicle device. By separating the in-vehicle device into two devices (the first in-vehicle device and the second in-vehicle device), it is possible to reduce the sizes of the individual devices, thus increasing the degree of freedom of arrangement in the vehicle. The first in-vehicle device (first processing unit) and the second in-vehicle device (second processing unit) are communicably connected by, for example, a network cable such as a CAN bus or an Ethernet (registered trademark) cable, and the second in-vehicle device (second processing unit) constantly monitors the operation state of the first in-vehicle device (first processing unit). If the first in-vehicle device (first processing unit) has failed, the second in-vehicle device (second processing unit) replaces the first in-vehicle device to perform on-off control of the first power feeding switch connected to the first in-vehicle device. Accordingly, it is possible to efficiently control the drive device.

A program according to an aspect of the present disclosure is a program for causing a computer to execute processing, the computer configured to be communicably connected to a drive device mounted in a vehicle and including a first power feeding switch connected to a first in-vehicle load and a second power feeding switch connected to a second in-vehicle load, the computer including: a first processing unit configured to be communicably connected to the first power feeding switch, and output a first control signal for driving the first in-vehicle load to the first power feeding switch; and a second processing unit configured to be communicably connected to the second power feeding switch, and output a second control signal for driving the second in-vehicle load to the second power feeding switch, the processing including: causing the second processing unit to: determine whether the first processing unit has failed; and, if it is determined that the first processing unit has failed, output a third control signal for driving the first in-vehicle load to the first power feeding switch via a first signal line connecting the first processing unit and the first power feeding switch to each other.

According to such an aspect, it is possible to provide a program that causes a computer to function as an in-vehicle device that efficiently controls a drive device.

An information processing method according to an aspect of the present disclosure is an information processing method for causing a computer to execute processing, the computer configured to be communicably connected to a drive device mounted in a vehicle and including a first power feeding switch connected to a first in-vehicle load and a second power feeding switch connected to a second in-vehicle load, the computer including: a first processing unit configured to be communicably connected to the first power feeding switch, and output a first control signal for driving the first in-vehicle load to the first power feeding switch; and a second processing unit configured to be communicably connected to the second power feeding switch, and output a second control signal for driving the second in-vehicle load to the second power feeding switch, the processing including: causing the second processing unit to: determine whether the first processing unit has failed; and, if it is determined that the first processing unit has failed, output a third control signal for driving the first in-vehicle load to the first power feeding switch via a first signal line connecting the first processing unit and the first power feeding switch to each other.

According to such an aspect, it is possible to provide an information processing method that causes a computer to function as an in-vehicle device that efficiently controls a drive device.

The present disclosure will be specifically described with reference to the drawings showing embodiments thereof. An in-vehicle system S according to an embodiment of the present disclosure will be described with reference to the drawings. It should be noted that the present disclosure is not limited to these examples, but is defined by the claims, and is intended to include all modifications which fall within the scope of the claims and the meaning and scope of equivalents thereof.

### Embodiment 1

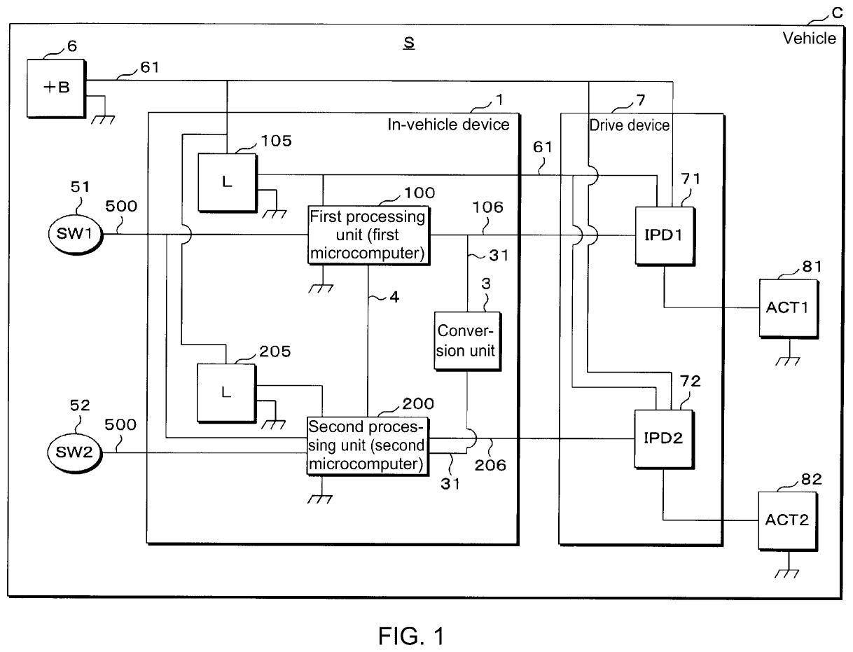

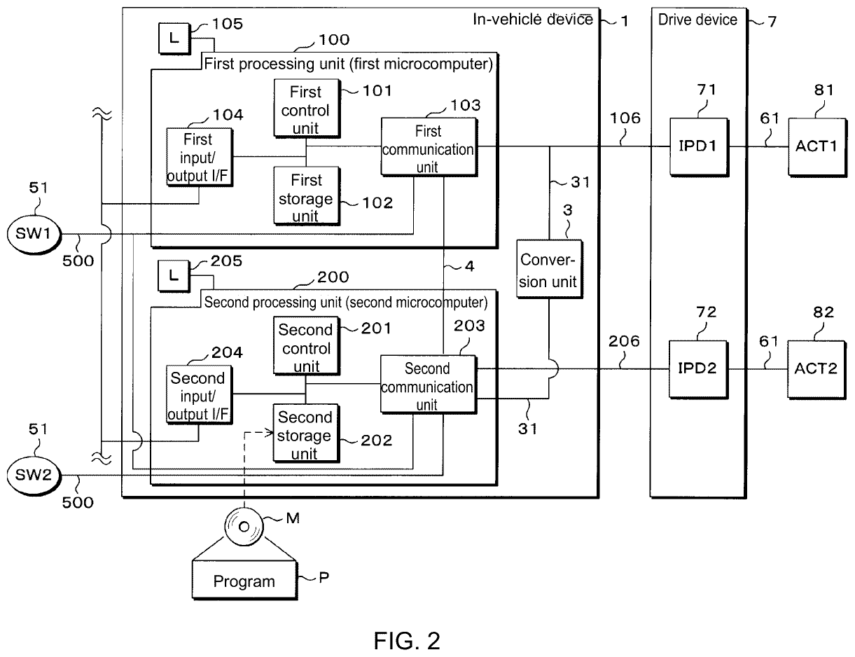

An embodiment will be described below with reference to the drawings. FIG. 1 is a schematic diagram illustrating a system configuration of the in-vehicle system S according to Embodiment 1. FIG. 2 is a block diagram illustrating an internal configuration of an in-vehicle device 1 and so forth included in the in-vehicle system S. The block diagram mainly shows forms of connection of a communication system. The in-vehicle system S includes the in-vehicle device 1 and a drive device 7 mounted in a vehicle C. The in-vehicle device 1 outputs a first control signal or a second control signal to the drive device 7 according to an operation signal output from a first operation switch 51 or a second operation switch 52.

If the first control signal has been obtained, the drive device 7 performs on-off control of a first power feeding switch 71, thus performing drive control of a first in-vehicle load 81 connected to the first power feeding switch 71. If the second control signal has been obtained, the drive device 7 performs on-off control of a second power feeding switch 72, thus performing drive control of a second in-vehicle load 82 connected to the second power feeding switch 72.

Power is supplied to the in-vehicle device 1 and the drive device 7 by a power supply device 6 mounted in the vehicle C. The power supply device 6 is connected to the in-vehicle device 1 and the drive device 7 by a power line 61. The drive device 7 and the first in-vehicle load 81 are connected to each other via the first power feeding switch 71 and the power line 61. The drive device 7 and the second in-vehicle load 82 are connected to each other via the second power feeding switch 72 and the power line 61.

The in-vehicle device 1 and the drive device 7 are communicably connected to each other by a first signal line 106 and a second signal line 206. The first control signal is output (transmitted) from the in-vehicle device 1 to the drive device 7 via the first signal line 106. The second control signal is output (transmitted) from the in-vehicle device 1 to the drive device 7 via the second signal line 206. In the present embodiment, the first signal line 106 and the second signal line 206 are each shown as a single wire. However, the present disclosure is not limited thereto. When communication between the in-vehicle device 1 and the drive device 7 is performed using, for example, SPI communication, the signal line used for the SPI communication may be constituted by an SPI communication circuit including a chip select (CS) signal line, a SCLK (clock) signal line, a master output/slave input (MOSI) signal line, and a master input/slave output (MISO) signal line. The in-vehicle device 1 and the drive device 7 may be further connected to each other by the power line 61, and the voltage lowered by a first regulator 105 included in the in-vehicle device 1 may be supplied (applied) to the drive device 7 via the power line 61.

The in-vehicle device 1 includes a first processing unit 100, a second processing unit 200, a first regulator 105, a second regulator 205, and a conversion unit 3. The in-vehicle device 1 may include a plurality of processing units (multiple microcomputers) composed of the first processing unit 100 (first microcomputer) and the second processing unit 200 (second microcomputer), each of which is constituted by a microcomputer or the like, and may be, for example, an integrated ECU constituted by a vehicle computer or the like. Alternatively, the in-vehicle device 1 may be a Power Lan Box (PLB) that also functions as a power distribution device that distributes and relays power that has been output from the power supply device 6, and supplies the power to the drive device 7 connected to itself (the in-vehicle device 1).

The first processing unit 100 is constituted by, for example, a microcomputer or the like, and includes a first control unit 101, a first storage unit 102, a first communication unit 103, and a first input/output I/F 104. The first control unit 101 is constituted by a Central Processing Unit (CPU), a Micro Processing Unit (MPU), or the like, and is configured to perform various types of control processing and arithmetic processing by reading out a program P (program product) and data stored in advance in the first storage unit 102. The first control unit 101 is not limited to a software processing unit such as a CPU that performs software processing, but may also include a hardware processing unit, such as an FPGA, an ASIC, or an SOC, that performs various types of control processing and arithmetic processing through hardware processing.

The first storage unit 102 is constituted by a volatile memory device such as a Random Access Memory (RAM) or a nonvolatile memory device such as a Read Only Memory (ROM), an Electrically Erasable Programmable ROM (EEPROM), a flash memory, or the like, and a control program P (program product) and data that is referred to during processing are stored in advance in the first storage unit 102. The program P (program product) stored in the first storage unit 102 may be a program P (program product) read out from a recording medium M that can be read by the in-vehicle device 1. Also, the program P may be a program P (program product) downloaded from an external computer (not shown) connected to a communication network and stored in the first storage unit 102.

The first communication unit 103 is, for example, a communication interface using a communication protocol of a Control Area Network (CAN) or Ethernet (registered trademark), and the first control unit 101 communicates, via the first communication unit 103, with various ECUs and the like connected to an in-vehicle network. The first control unit 101 may communicate with the second control unit 201 of the second processing unit 200 via the first communication unit 103 and the in-vehicle network.

The first input/output I/F 104 is, for example, a communication interface for performing SPI communication or the like, and is constituted by, for example, a plurality of connectors or terminals. For example, the first operation switch 51, the first power feeding switch 71, and a second input/output I/F 204 are connected to the first input/output I/F 104. The first input/output I/F 104 and the first operation switch 51 are connected to each other via a communication cable 500. The first input/output I/F 104 and the first power feeding switch 71 are connected to each other via the first signal line 106. The first input/output I/F 104 and the second input/output I/F 204 are connected to each other via an inter-microcomputer communication line 4. The inter-microcomputer communication line 4 may be constituted by, for example, an internal bus.

The second processing unit 200 is constituted by, for example, a microcomputer or the like, and includes a second control unit 201, a second storage unit 202, a second communication unit 203, and a second input/output I/F 204. The second control unit 201, the second storage unit 202, the second communication unit 203, and the second input/output I/F 204 of the second processing unit 200 may have the same configurations or specifications as the first control unit 101, the first storage unit 102, the first communication unit 103, and the first input/output I/F 104, respectively, of the first processing unit 100.

The second input/output I/F 204 is, for example, a communication interface for performing SPI communication or the like, and is composed of, for example, a plurality of connectors or terminals. For example, the second operation switch 52, the second power feeding switch 72, and the first input/output I/F 104 are connected to the second input/output I/F 204. As described above, the second input/output I/F 204 of the second processing unit 200 and the first input/output I/F 104 of the first processing unit 100 are connected to each other by the inter-microcomputer communication line 4, whereby the second control unit 201 of the second processing unit 200 can monitor whether the first processing unit 100 is operating normally.

A connecting line 31 is further connected to the second input/output I/F 204, and the connecting line 31 is connected to the first signal line 106 connecting the first processing unit 100 and the first operation switch 51 to each other. The connecting line 31 is provided with a conversion unit 3. Although described in detail later, if the first processing unit 100 has caused a malfunction (functional failure), the second control unit 201 of the second processing unit 200 (second microcomputer) outputs, via the connecting line 31, a third control signal for replacing the first processing unit 100.

The conversion unit 3 is constituted by, for example, a circuit, an integrated circuit (IC), or the like that performs signal conversion, including, for example, a filter circuit, a PWM waveform conversion circuit, and an output voltage conversion circuit. Although described in detail later, the conversion unit 3 converts the third control signal output from the second processing unit 200 (second microcomputer) into the first control signal that is output by the first processing unit 100 (first microcomputer) in a normal state.

The first regulator 105 is a switching regulator, a linear regulator, or the like that is connected to the power supply device 6, lowers the voltage applied from the power supply device 6, and applies the lowered voltage to the first processing unit 100 (first microcomputer) and the drive device 7. The first regulator 105 and the drive device 7 are connected to each other by the power line 61, and power obtained with the voltage lowered by the first regulator 105 is supplied to the drive device 7.

Similarly to the first regulator 105, the second regulator 205 is constituted by a switching regulator or the like. The voltage lowered by the second regulator 205 is applied to the second processing unit 200 (second microcomputer), and is used as the operating voltage of the second processing unit 200.

The power supply device 6 is constituted by a secondary battery or the like such as a lead-acid battery, an alternator, or a lithium battery, and outputs (applies) a voltage of 12 V, for example. The power supply device 6 is connected to the in-vehicle device 1 and the drive device 7 by a power line. The power supply device 6 is connected to the first in-vehicle load 81 and the second in-vehicle load 82 via the drive device 7.

The drive device 7 includes the first power feeding switch 71 and the second power feeding switch 72, and may function as an extender including a drive circuit for driving in-vehicle loads (the first in-vehicle load 81 and the second in-vehicle load 82) such as actuators connected to the drive device 7. The voltage lowered by the first regulator 105 is applied to the drive device 7. The drive device 7 uses the lowered voltage as the operating voltages of the first power feeding switch 71 and the second power feeding switch 72, each of which is constituted by an Intelligent Power Device (IPD) or the like.

The first power feeding switch 71 and the second power feeding switch 72 are each constituted by an Intelligent Power Device (IPD) including, for example, a switching element such as a Field Effect Transistor (FET) or an Insulated Gate Bipolar Transistor (IGBT). The first signal line 106 is connected to the first power feeding switch 71. The first power feeding switch 71 performs on-off control in response to the first control signal such as a PWM signal being input via the first signal line 106. The first in-vehicle load 81 is connected to the switching element included in the first power feeding switch 71 by a power line, and power from the power supply device 6 is supplied to the first in-vehicle load 81 in response to the first power feeding switch 71 being turned on. The second signal line 206 is connected to the second power feeding switch 72. The second power feeding switch 72 performs on off control in response to the second control signal such as a PWM signal being input via the second signal line 206. The second in-vehicle load 82 is connected to the switching element included in the second power feeding switch 72 by a power line, and power from the power supply device 6 is supplied to the second in-vehicle load 82 in response to the second power feeding switch 72 being turned on.

The first operation switch 51 is an operation switch for operating the first in-vehicle load 81, and is operated by, for example, an occupant of the vehicle C. For example, when the first in-vehicle load 81 is a wiper, the first operation switch 51 corresponds to a wiper switch. The first operation switch 51 is connected, via a communication cable 500, to a terminal (first input/output I/F 104) of the first processing unit 100 and a terminal (second input/output I/F 204) of the second processing unit 200.

The second operation switch 52 is an operation switch for operating the second in-vehicle load 82, and is operated by, for example, an occupant of the vehicle C. For example, when the second in-vehicle load 82 is a door mirror, the second operation switch 52 corresponding to a door mirror switch is connected to a terminal (second input/output I/F 204) of the second processing unit 200 via a communication cable 500.

The first in-vehicle load 81 is, for example, an actuator such as a wiper, and is connected to the first power feeding switch 71 of the drive device 7 via a power line. In response to the first power feeding switch 71 being turned on, the power output from the power supply device 6 via the first power feeding switch 71 is supplied to the first in-vehicle load 81.

The second in-vehicle load 82 is, for example, an actuator such as a door mirror, and is connected to the second power feeding switch 72 of the drive device 7 via a power line. In response to the second power feeding switch 72 being turned on, the power output from the power supply device 6 is supplied to the second in-vehicle load 82 via the second power feeding switch 72.

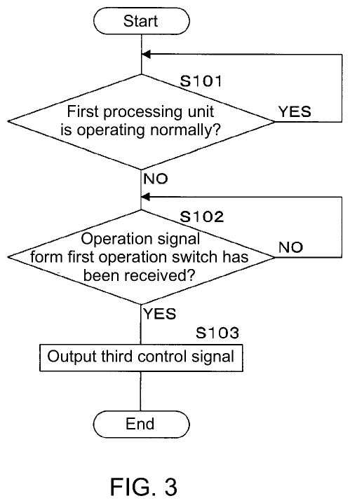

FIG. 3 is a flowchart illustrating processing performed by the second processing unit 200 included in the in-vehicle device 1. The first processing unit 100 (first microcomputer) and the second processing unit 200 (second microcomputer) of the in-vehicle device 1 are configured to output, to the drive device 7, control signals (first control signal, second control signal) according to operation signals from the operation switches (the first operation switch 51, the second operation switch 52) respectively connected thereto. In this manner, the first processing unit 100 and the second processing unit 200 perform control processing for different operation systems (driving system). In addition, the second processing unit 200 (second microcomputer) steadily performs the following processing, for example, when the vehicle C is in an activated state (IG switch is on) or a stopped state (IG switch is off).

The second control unit 201 of the second processing unit 200 determines whether the first processing unit 100 is operating normally (S101). The second control unit 201 of the second processing unit 200 cyclically or steadily monitors the operating state of the first processing unit 100 by cyclically or periodically performing polling with the first processing unit 100 via, for example, the inter-microcomputer communication line 4 constituted by an internal bus or the like. Alternatively, the first control unit 101 of the first processing unit 100 may be configured to cyclically or periodically output (transmit) a heart-beat signal to, for example, the second processing unit 200 via the inter-microcomputer communication line 4, and the second control unit 201 of the second processing unit 200 may determine whether the first processing unit 100 is operating normally, based on determination as to whether the heart-beat signal has been received.

If it is determined that that the first processing unit 100 is operating normally (S101: YES), the second control unit 201 of the second processing unit 200 performs loop processing to perform the processing of S101 again. By performing loop processing in this manner, the second control unit 201 of the second processing unit 200 continues the monitoring of the operation of the first processing unit 100. In this manner, the second processing unit 200 that monitors whether the first processing unit 100 is operating normally may function as a watchdog timer (WDT) for the first processing unit 100.

If it is determined that the first processing unit 100 is not operating normally (S101: NO), the second control unit 201 of the second processing unit 200 determines whether an operation signal from the first operation switch 51 has been obtained (S102). The communication cable 500 extending from the first operation switch 51 is branched into two portions, and thus is connected to both the first processing unit 100 and the second processing unit 200. The second control unit 201 of the second processing unit 200 determines whether an operation signal from the first operation switch 51 has been obtained (received) via the communication cable 500 branched in this manner.

If it is determined that an operation signal from the first operation switch 51 has not been obtained (S102: NO), the second control unit 201 of the second processing unit 200 performs loop processing to perform the processing of S102 again. By performing loop processing in this manner, the second control unit 201 of the second processing unit 200 continues the processing for waiting for an operation signal from the first operation switch 51.

If it is determined that an operation signal from the first operation switch 51 has been obtained (S102: YES), the second control unit 201 of the second processing unit 200 outputs a third control signal (S103). The second control unit 201 of the second processing unit 200 outputs the third control signal via the terminal (second input/output I/F 204) to which the connecting line 31 is connected. The third control signal output via the connecting line 31 is converted, by the conversion unit 3 provided in the connecting line 31, the first control signal that is output by the first processing unit 100 (first microcomputer) in a normal state. The first control signal converted by the conversion unit 3 propagates through the connecting line 31 and the first signal line 106 to which the connecting line 31 is connected, and is output to the first power feeding switch 71 via the first signal line 106. The first power feeding switch 71 performs on-off control according to the input first control signal, whereby drive control for the first in-vehicle load 81 connected to the first power feeding switch 71 is performed. Thus, for example, even if the first processing unit 100 has functionally failed, the second processing unit 200 can replace the first processing unit 100 to output the third control signal, and thus can continue the drive control (perform fail-safe) for the first in-vehicle load 81, making it possible to increase the reliability of the in-vehicle device 1.

In the present embodiment, the third control signal from the second processing unit 200 (second microcomputer) is converted into the first signal line 106 by the conversion unit 3, and the converted first signal line 106 is output to the first power feeding switch 71 via the first signal line 106. However, the present disclosure is not limited thereto. The third control signal from the second processing unit 200 (second microcomputer) may have the same signal form (specification) as the first control signal that is output by the first processing unit 100 (first microcomputer) in a normal state, and the third control signal may be output to the first power feeding switch 71 via the connecting line 31 and the first signal line 106. In this case, the conversion unit 3 is not necessary.

In the present embodiment, the second processing unit 200 (second microcomputer) replaces the first processing unit 100 (first microcomputer), for example, outputs the third control signal, according to the operation signal output from the first operation switch 51. However, the present disclosure is not limited thereto. The second processing unit 200 (second microcomputer) may replace the first processing unit 100 (first microcomputer), for example, output the third control signal, according to communication data, such as a CAN message, obtained via the second communication unit 203. That is, if a CAN message obtained via the second communication unit 203 is a message ID (CAN-ID) for driving the first in-vehicle load 81, the second processing unit 200 (second microcomputer) may replace the first processing unit 100 (first microcomputer), for example, output the third control signal, according to the obtained CAN message.

### Embodiment 2

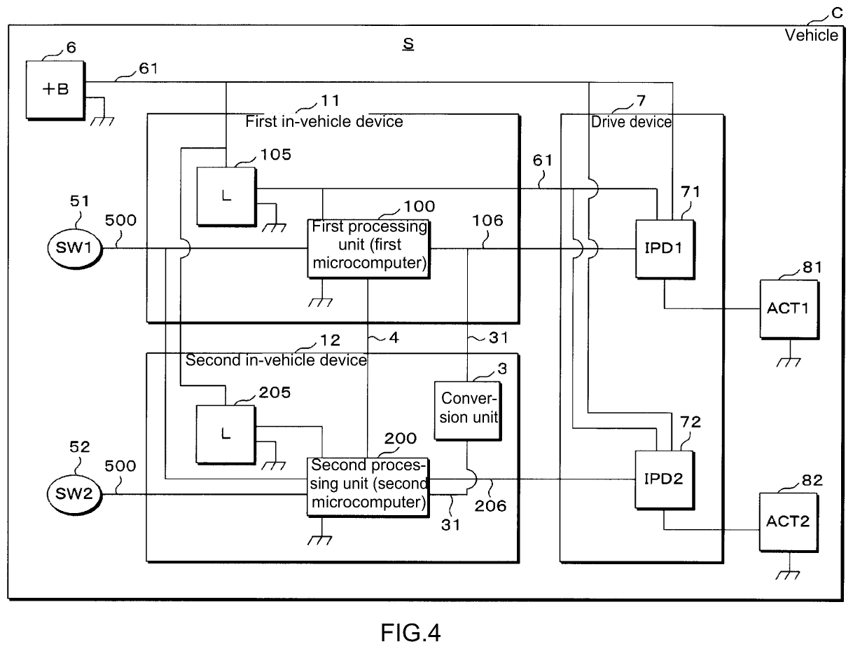

FIG. 4 is a schematic diagram illustrating a system configuration of an in-vehicle system S according to Embodiment 2 (separate in-vehicle devices 1). The in-vehicle system S of Embodiment 2 is constituted by separate in-vehicle devices 1 composed of a first in-vehicle device 11 including a first processing unit 100 (first microcomputer), and a second in-vehicle device 12 including a second processing unit 200 (second microcomputer). That is, the in-vehicle device 1 in a multi-microcomputer form including the first processing unit 100 (first microcomputer) and the second processing unit 200 (second microcomputer) described in Embodiment 1 corresponds, in Embodiment 2, to a device configuration formed by a combination of the first in-vehicle device 11 including the first processing unit 100 (first microcomputer) and the second processing unit 200 (second microcomputer) including the second in-vehicle device 12.

In the present embodiment, the in-vehicle system S includes separate in-vehicle devices 1 composed of the first in-vehicle device 11 and the second in-vehicle device 12, but the forms of connection between the first processing unit 100 (first microcomputer) and the second processing unit 200 (second microcomputer) are the same as the corresponding forms of connection in Embodiment 1. That is, similarly to the first processing unit 100 (first microcomputer) and the second processing unit 200 (second microcomputer) in Embodiment 1, the first in-vehicle device 11 and the second in-vehicle device 12 are communicably connected to each other via an inter-microcomputer communication line 4. The first in-vehicle device 11 and the second in-vehicle device 12 may be communicably connected to each other via a first communication unit 103, a second communication unit 203, and a CAN bus or an Ethernet cable.

The form of connection between the first processing unit 100 (first microcomputer) and the first power feeding switch 71, and the form of connection between the second processing unit 200 (second microcomputer) and the second power feeding switch 72 are the same as the corresponding forms of connection in Embodiment 1. That is, the first in-vehicle device 11 is connected to a first power feeding switch 71 of a drive device 7 via a first signal line 106, and the second in-vehicle device 12 is connected to a second power feeding switch 72 of the drive device 7 via a second signal line 206.

As in the case of Embodiment 1, the second in-vehicle device 12 including the second processing unit 200 cyclically or steadily performs the monitoring processing for determining whether the first in-vehicle device 11 including the first processing unit 100 is operating normally. If it is determined that the first processing unit 100 of the first in-vehicle device 11 is in an abnormal state (functionally failed), the second processing unit 200 of the second in-vehicle device 12 outputs the third control signal via the connecting line 31.

As in the case of Embodiment 1, the second in-vehicle device 12 includes a conversion unit 3. The third control signal output via the connecting line 31 is converted into the first control signal by the conversion unit 3. The first control signal converted by the conversion unit 3 is input to the first power feeding switch 71 via the first signal line 106 connecting the first in-vehicle device 11 and the first power feeding switch 71 to each other.

Even when each of the first in-vehicle device 11 and the second in-vehicle device 12 is an in-vehicle device 1 in a single-microcomputer form constituted by a single microcomputer or the like, the second in-vehicle device 12 (second processing unit 200) replaces the first in-vehicle device 11 (first processing unit 100) if the first in-vehicle device 11 has failed, and performs on off control of the first power feeding switch 71 connected to the first in-vehicle device 11. Thus, it is possible to construct a fail-safe environment for the first in-vehicle load 81.

### Embodiment 3

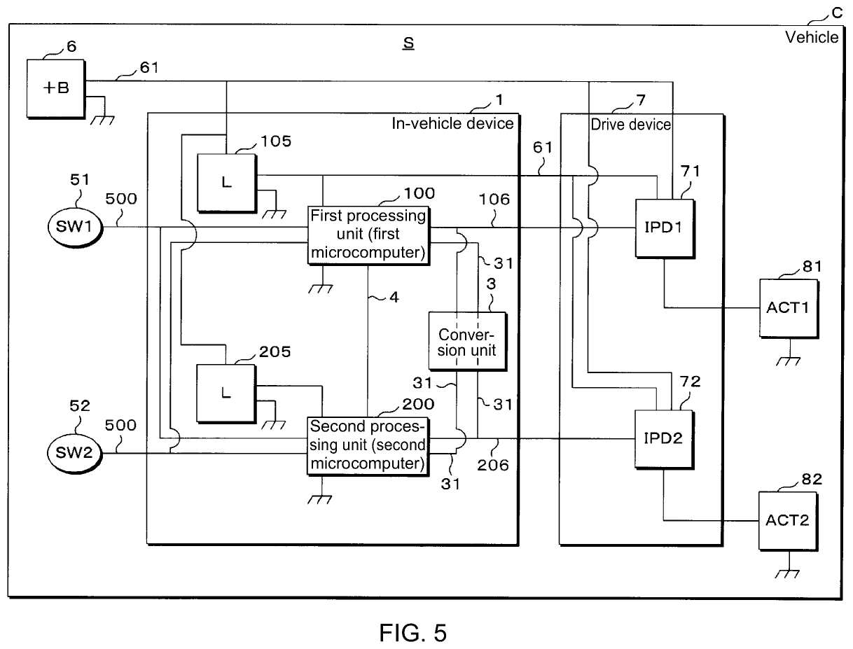

FIG. 5 is a schematic diagram illustrating a system configuration of an in-vehicle system S according to Embodiment 3 (mutual replacement). Similarly to the in-vehicle device 1 according to Embodiment 1, the in-vehicle device 1 according to Embodiment 3 includes a first processing unit 100, a second processing unit 200, a first regulator 105, a second regulator 205, and a conversion unit 3. The respective configurations of the first processing unit 100, the second processing unit 200, the first regulator 105, the second regulator 205, and the conversion unit 3 are the same as those in Embodiment 1.

In the in-vehicle device 1 according to Embodiment 3, not only a communication cable 500 extending from the first operation switch 51, but also a communication cable 500 extending from the second operation switch 52 is branched, and respective end portions (branched ends) of the branched communication cable 500 are connected to the first processing unit 100 (first microcomputer) and the second processing unit 200 (second microcomputer), respectively. Similarly to the communication cable 500 extending from the first operation switch 51, the communication cable 500 extending from the second operation switch 52 is branched, and the branched communication cable 500 is connected to a terminal (first input/output I/F 104) of the first processing unit 100 and a terminal (second input/output I/F 204) of the second processing unit 200. Thus, an operation signal from the second operation switch 52 is input to both the first processing unit 100 (first microcomputer) and the second processing unit 200 (second microcomputer). As in the case of Embodiment 1, an operation signal from the first operation switch 51 is input to both the first processing unit 100 (first microcomputer) and the second processing unit 200 (second microcomputer).

A connecting line 31 similar to the connecting line 31 of Embodiment 1 is connected to the first input/output I/F 104 of the first processing unit 100 (first microcomputer), and the connecting line 31 is connected to a second signal line 206 connecting the second input/output I/F 204 of the second processing unit 200 and the second power feeding switch 72 to each other. As in the case of Embodiment 1, the connecting line 31 connecting the first input/output I/F 104 of the first processing unit 100 and the second signal line 206 to each other is provided with a conversion unit 3. Accordingly, the conversion unit 3 is disposed so as to straddle two connecting line 31 composed of the connecting line 31 connecting the first input/output I/F 104 of the first processing unit 100 and the second signal line 206 to each other, and the connecting line 31 connecting the second input/output I/F 204 of the second processing unit 200 and the first signal line 106 to each other.

The first control unit 101 of the first processing unit 100 (first microcomputer) cyclically or steadily performs the monitoring processing for determining whether the second processing unit 200 (second microcomputer) is operating normally. The monitoring processing may be performed by performing polling communication via an inter-microcomputer communication line 4 or by using a heart-beat signal, as in the case of the monitoring processing for the first processing unit 100 (first microcomputer) performed by the second control unit 201 of the second processing unit 200 (second microcomputer) in Embodiment 1. If it is determined that the second processing unit 200 (second microcomputer) is in an abnormal state (functionally failed), the first control unit 101 of the first processing unit 100 (first microcomputer) outputs a fourth control signal via the connecting line 31.

The conversion unit 3 converts the fourth control signal output from the first processing unit 100 (first microcomputer) into a second control signal that is output by the second processing unit 200 (second microcomputer) in a normal state. The second control signal converted by the conversion unit 3 propagates through the connecting line 31, and the second signal line 206 to which the connecting line 31 is connected, and is output to the second power feeding switch 72 via the second signal line 206.

The second power feeding switch 72 performs on-off control according to the input second control signal, whereby drive control for a second in-vehicle load 82 that is connected to the second power feeding switch 72 is performed. Thus, for example, even when the second processing unit 200 has functionally failed, the first processing unit 100 can replace the second processing unit 200 to output the fourth control signal, thus making it possible to continue the drive control (fail-safe) for the second in-vehicle load 82. Each of the first processing unit 100 (first microcomputer) and the second processing unit 200 (second microcomputer) included in the in-vehicle device 1 monitors the processing performed by the other processing unit. If the other processing unit has entered an abnormal state (functionally failed), the first and second processing unit 100 and 200 perform processing for replacing each other, and it is therefore possible to continue the drive control for the first in-vehicle load 81 and the second in-vehicle load 82, thus increasing the reliability of the in-vehicle device 1.

When the first processing unit 100 (first microcomputer) and the second processing unit 200 (second microcomputer) perform the processing for replacing each other, the control signals (first control signal and second control signal converted by the conversion unit 3) that are output to the drive device 7 are output via the first signal line 106 or the second signal line 206. Accordingly, there is no need to additionally install signal lines in order to construct a fail-safe environment for the first in-vehicle load 81 and the second in-vehicle load 82, and it is thus possible to reduce the product costs and the device weight.

It should be appreciated that the embodiments disclosed herein are to be construed in all respects as illustrative and not limiting. The scope of the present disclosure is defined by the claims, rather than by the description preceding them, and is intended to include all modifications which fall within the scope of the claims and the meaning and scope of equivalents thereof.

A plurality of claims recited in the claims can be combined with one another, regardless of the claims to which they refer. In the claims, a multiple dependent claim depending on a plurality of claims may be recited. A multiple dependent claim depending on a multiple dependent claim may be recited. Even in the case where no multiple dependent claim depending on a multiple dependent claim is recited, this does not limit the recitation of a multiple dependent claim depending on a multiple dependent claim.

1. An in-vehicle device configured to be communicably connected to a drive device mounted in a vehicle and including a first power feeding switch connected to a first in-vehicle load and a second power feeding switch connected to a second in-vehicle load, the in-vehicle device including:
a first processing unit configured to be communicably connected to the first power feeding switch, and output a first control signal for driving the first in-vehicle load to the first power feeding switch,
a second processing unit configured to be communicably connected to the second power feeding switch, and output a second control signal for driving the second in-vehicle load to the second power feeding switch, wherein
the first processing unit and the second processing unit are communicably connected to each other,
if the first processing unit has failed, the second processing unit outputs a third control signal for driving the first in-vehicle load to the first power feeding switch via a first signal line connecting the first processing unit and the first power feeding switch to each other,
the in-vehicle device further includes a connecting line,
the first signal line and the second processing unit are connected to each other by a connecting line,
if the first processing unit has failed, the second processing unit outputs the third control signal via the connecting line and the first signal line,
the connecting line is provided with a conversion unit configured to convert the third control signal into the first control signal,
the third control signal output by the second processing unit via the connecting line is converted into the first control signal by the conversion unit, and
the first control signal converted by the conversion unit is output to the first power feeding switch via the first signal line.

2. (canceled)

3. (canceled)

4. The in-vehicle device according to claim 1, wherein
a communication cable extending from an operation switch for operating the first in-vehicle load is connected to the first processing unit and the second processing unit.

5. The in-vehicle device according to claim 1, wherein
the in-vehicle device is composed of a first in-vehicle device and a second in-vehicle device,
the first in-vehicle device includes the first processing unit,
the second in-vehicle device includes the second processing unit, and,
if the first in-vehicle device has failed, the second in-vehicle device replaces the first in-vehicle device.

6. A program for causing a computer to execute processing,
the computer configured to be communicably connected to a drive device mounted in a vehicle and including a first power feeding switch connected to a first in-vehicle load and a second power feeding switch connected to a second in-vehicle load, the computer including:
a first processing unit configured to be communicably connected to the first power feeding switch, and output a first control signal for driving the first in-vehicle load to the first power feeding switch; and
a second processing unit configured to be communicably connected to the second power feeding switch, and output a second control signal for driving the second in-vehicle load to the second power feeding switch, the processing including:
causing the second processing unit to:
determine whether the first processing unit has failed; if it is determined that the first processing unit has failed, output a third control signal for driving the first in-vehicle load to the first power feeding switch via a first signal line connecting the first processing unit and the first power feeding switch to each other,
the computer is provided with a connecting line,
the in-vehicle device further includes a connecting line,
the first signal line and the second processing unit are connected to each other by a connecting line,
if the first processing unit has failed, the program causes the second processing unit to output the third control signal via the connecting line and the first signal line,
the connecting line is provided with a conversion unit configured to convert the third control signal into the first control signal,
the third control signal output by the second processing unit via the connecting line is converted into the first control signal by the conversion unit, and
the first control signal converted by the conversion unit is output to the first power feeding switch via the first signal line.

7. An information processing method for causing a computer to execute processing,
the computer configured to be communicably connected to a drive device mounted in a vehicle and including a first power feeding switch connected to a first in-vehicle load and a second power feeding switch connected to a second in-vehicle load, the computer including:
a first processing unit configured to be communicably connected to the first power feeding switch, and output a first control signal for driving the first in-vehicle load to the first power feeding switch; and
a second processing unit configured to be communicably connected to the second power feeding switch, and output a second control signal for driving the second in-vehicle load to the second power feeding switch, the processing including:
causing the second processing unit to:
determine whether the first processing unit has failed;
if it is determined that the first processing unit has failed, output a third control signal for driving the first in-vehicle load to the first power feeding switch via a first signal line connecting the first processing unit and the first power feeding switch to each other,
the computer is provided with a connecting line,
the in-vehicle device further includes a connecting line,
the first signal line and the second processing unit are connected to each other by a connecting line,
if the first processing unit has failed, the program causes the second processing unit to output the third control signal via the connecting line and the first signal line,
the connecting line is provided with a conversion unit configured to convert the third control signal into the first control signal,
the third control signal output by the second processing unit via the connecting line is converted into the first control signal by the conversion unit, and
the first control signal converted by the conversion unit is output to the first power feeding switch via the first signal line.

8. The in-vehicle device according to claim 4, wherein
the in-vehicle device is composed of a first in-vehicle device and a second in-vehicle device,
the first in-vehicle device includes the first processing unit,
the second in-vehicle device includes the second processing unit, and,
if the first in-vehicle device has failed, the second in-vehicle device replaces the first in-vehicle device.
